(19) United States
(12) Patent Application Publication
(10) Pub. No.: US 2018/0143496 A1
(43) Pub. Date: May 24, 2018

(54) LIGHTING DEVICE, DISPLAY DEVICE, AND TELEVISION DEVICE

(71) Applicant: SHARP KABUSHIKI KAISHA, Sakai City, Osaka (JP)

(72) Inventor: MITSURU HOSOKI, Sakai City (JP)

(21) Appl. No.: 15/572,097

(22) PCT Filed: Apr. 27, 2016
(86) PCT No.: PCT/JP2016/063179

§ 371 Date: Nov. 6, 2017

(30) Foreign Application Priority Data
May 8, 2015 (JP) 2015-095498

(51) Int. Cl. G02F 1/1335; F21V 8/00

(52) U.S. Cl. CPC G02F 1/133615; G02B 6/0031; G02B 6/0085; G02B 6/0073; G02F 1/133553

(57) ABSTRACT

A lighting device includes light sources, a light guide plate, light source boards, and a light reflecting member. The light guide plate includes at least one end surface configured as a light entering surface through which light rays from the light sources enter and one of plate surfaces configured as a light exiting surface through which the light rays entering through the light entering surface exit. Each light source board includes one of plate surface configured as a mounting surface on which the light sources are mounted. The light source boards are arranged along the light entering surface with mounting surfaces opposed to the light entering surface. The light reflecting member has light reflectively. The light reflecting member is opposed to a section of an edge of the light exiting surface facing a space between the adjacent light source boards on a light entering surface side.

### TECHNICAL FIELD

The present invention relates to a lighting device, a display device, and a television device.

### BACKGROUND ART

Liquid crystal panels in liquid crystal display devices such as liquid crystal television devices do not produce light and thus backlight units that are separately prepared lighting units are required. The backlight units are broadly classified into direct types and edge light types based on their mechanisms. To reduce thicknesses of the liquid crystal display devices, edge light type backlight units are preferable.

An edge light type backlight unit includes a light guide plate and a light source board held in a case. The light guide plate includes an end surface that is configured as a light entering surface and one of plate surfaces that is configured as a light exiting surface. The light source board includes a mounting surface on which light sources such as light emitting diodes (LEDs) are mounted. The mounting surface is opposed to the light exiting surface of the light guide plate. In such a backlight unit, uneven brightness may occur in light that exits the light guide plate through the light exiting surface. A technology for suppressing such uneven brightness is required. Patent document 1 discloses a technology for suppressing uneven brightness around positioning protrusions on a light guide plate in a lighting unit that produces planar light.

### RELATED ART DOCUMENT

### Patent Document

Patent Document 1: Unexamined Japanese Patent Application Publication No. 2005-302485

### Problem to be Solved by the Invention

In recent years, the demand for a high definition liquid crystal panel or a high color reproducible liquid crystal panel increases. In such a panel, high brightness is required in light that exits from a light guide plate through the light exiting surface in a backlight unit for supplying the light to the liquid crystal panel. Therefore, a large number of light sources are required. To dispose a large number of light sources in a case of the backlight unit, light source boards may be disposed along a light entering surface of the light guide plate.

When the light source boards are disposed along the light entering surface of the light guide plate, a distance between the adjacent light sources on the different light source boards may be larger than a distance between the adjacent light sources mounted on amounting surface of the light source board. When an edge of the light exiting surface of the light guide plate on a light entering surface side is viewed, a section of the edge facing a gap between the adjacent light source boards may be displayed darker than other portions. Namely, a dark spot may appear at the section facing the gap. This may cause uneven brightness in the light that exits from the light guide plate through the light exiting surface.

### DISCLOSURE OF THE PRESENT INVENTION

The present invention was made in view of the above circumstances. An object is to suppress uneven brightness.

### Means for Solving the Problem

The technology described herein relates to a lighting device including light sources, a light guide plate, light source boards, and a light reflecting member. The light guide plate includes at least an end surface configured as a light entering surface through which light rays from the light sources enter and one of plate surfaces configured as a light exiting surface through which the light rays entering through the light entering surface exit. The light source boards include plate surfaces configured as mounting surfaces on which the light sources are mounted. The light source boards are disposed along the light entering surface with the mounting surfaces opposed to the light entering surface. Each mounting surface is one of plate surfaces of each light source board. The light reflecting member has light reflectivity. The light reflecting member is disposed to a section of an edge of the light exiting surface facing a space between the adjacent light source boards on a light entering surface side.

In a lighting device having a configuration in which light source boards are disposed along a light entering surface of a light guide plate, a distance between light sources that are adjacent to each other is larger than an interval of light sources mounting surfaces of light source boards. Therefore, a dark spot may be produced in a section of an edge of a light exiting surface of the light guide plate facing a space between the adjacent light source boards. This may result in uneven brightness in light exiting through the light exiting surface. In the lighting device described earlier, the light rays that have exited the light guide plate through the light exiting surface and reached the light reflecting member are reflected by the light reflecting member to the section of the edge of the light exiting surface of the light guide plate facing the space between the adjacent light source boards on the light entering surface side. The reflected light rays reach the dark spot in the section facing the space and therearound and thus the dark spot can be eliminated. According to the configuration, the uneven brightness resulting from the dark spot is less likely to occur in light exiting the light guide plate through the light exiting surface.

The lighting device may include a frame member including a covering section that covers an edge of the light exiting surface. The light reflecting member may be bonded to an area of the covering section.

If the light reflecting member is disposed on the light exiting surface of the light guide plate, the optical sheet disposed on the light exiting surface may contact the light reflecting member when the optical sheet is thermally expanded. In the configuration described earlier, the light reflecting member is bonded to the covering section of the frame member. Therefore, the light reflecting member is less likely to contact other components.

The lighting device may include a frame member including a covering section that covers an edge of the light exiting surface. The light reflecting member may be an area of the covering section painted in white.

In this configuration, the thickness of the light reflecting member is equal to the thickness of the paint. In comparison to a configuration in which the light reflecting member has a sheet shape, the thickness of the light reflecting member is smaller. Therefore, the thickness of the lighting device can be reduced.

The light reflecting member may be bonded to an area of a section of an edge of the light exiting surface on a light entering surface side.

According to the configuration, specific arrangement of the light reflecting member is provided.

The lighting device may include an optical sheet bundle including optical sheets that are disposed in layers on the light exiting surface. The optical sheet that is located at an upper side among the optical sheets may include a protrusion that protrudes toward the light source board at an edge of the optical sheet on a light entering surface side. The light reflecting member may be bonded to the protrusion.

If the light reflecting member is disposed on the light exiting surface of the light guide plate, the optical sheet disposed on the light exiting surface may contact the light reflecting member when the optical sheet is thermally expanded. In the configuration described earlier, the light reflecting member is bonded to the protrusion of the optical sheet. Therefore, the light reflecting member is less likely to contact other components.

The technology described herein relates to a lighting device including light sources, a light guide plate, light source boards, and a light diffusing member. The light guide plate includes at least an end surface configured as a light entering surface through which light rays from the light sources enter and one of plate surfaces configured as a light exiting surface through which the light rays entering through the light entering surface exit. The light source boards include plate surfaces configured as mounting surfaces on which the light sources are mounted. The light source boards are disposed along the light entering surface with the mounting surfaces opposed to the light entering surface. Each mounting surface is one of plate surfaces of each light source board. The light diffusing member has a light diffusing property. The light diffusing member is opposed to a section of an edge of the light exiting surface of the light guide plate facing a space between the adjacent light source boards on a light entering surface side.

In the lighting device, light rays that have exited the light guide plate through the light exiting surface and reached the light diffusing member are diffused by the light diffusing member to the section of the edge of the light exiting surface of the light guide plate facing the space between the adjacent light source boards on the light entering surface side. According to the configuration, brightness in a dark spot produced in the section facing the space and therearound increases and thus a difference in brightness between the dark spot and other sections decreases. Therefore, uneven brightness resulting from the dark spot is less likely to occur in light exiting the light guide plate through the light exiting surface.

The lighting device may include an optical member including optical sheets that are disposed in layers on the light exiting surface. The optical sheets are configured to exert optical effects on light rays exiting from the light exiting surface. At least one of the optical sheets may include a protrusion that protrudes toward the light source board at an edge of the optical sheet on a light entering surface side. The protrusion may be the light diffusing member.

In the above configuration, a portion of the optical sheet is configured as the light diffusing member. Therefore, a separate light diffusing member is not required and thus the part cost can be reduced.

In the lighting device, the light source boards may be made of metal.

A metal light source board delivers higher heat dissipation performance in comparison to a resin light source board; however, a dimension of the metal light source board in an extending direction thereof is smaller than that of the resin light source board. In a large-sized lighting device, a large number of light source boards need to be disposed along a light entering surface of a light guide plate. In the configuration described earlier, even if a large number of light source boards are disposed, uneven brightness resulting from the dark spot in each section of the edge of the light guide plate facing the space between the adjacent light source boards is less likely to occur. Therefore, a large-sized lighting device can be provided while the uneven brightness is reduced and the heat dissipation performance is improved.

The technology described herein relates to a display device including the lighting device described above and a display panel configured to display an image using light supplied by the lighting device. Such a display device is new and advantageous. Furthermore, a television device including the display device described above is new and advantageous.

### Advantageous Effect of the Invention

According to the technology described herein, in an edge light type backlight unit, uneven brightness is less likely to occur in light exiting from the light guide plate.

### BRIEF DESCRIPTION OF THE DRAWINGS

FIG. 1 is an exploded perspective view illustrating a general configuration of a television device according to a first embodiment of the present invention.

FIG. 2 is an exploded perspective view illustrating a general configuration of a liquid crystal display device.

FIG. 3 is a cross-sectional view along a short direction of the liquid crystal display device.

FIG. 4 is a magnified cross-sectional view on an LED board side in FIG. 3.

FIG. 5 is a plan view of a backlight unit viewed from the front side.

FIG. 6 is a magnified plan view of a portion of an edge of the light exiting surface of a light guide plate facing a gap between adjacent LED boards and therearound.

FIG. 7 is a plan view of a backlight unit viewed from the front side in a modification of the first embodiment.

FIG. 8 is a magnified cross-sectional view on an LED board side in a liquid crystal display device according to a second embodiment.

FIG. 9 is a magnified plan view of a portion of an edge of the light exiting surface of a light guide plate facing a gap between adjacent LED boards and therearound in the second embodiment.

FIG. 10 is a picture illustrating brightness in the portion of the edge of the light exiting surface of the light guide plate facing the gap between the adjacent LED boards and therearound in the second embodiment.

FIG. 11 is a magnified cross-sectional view on an LED board side in a liquid crystal display device according to a third embodiment.

FIG. 12 is a magnified plan view of a portion of an edge of the light exiting surface of a light guide plate facing a gap between adjacent LED boards and therearound in the third embodiment.

FIG. 13 is a picture illustrating brightness in the portion of the edge of the light exiting surface of the light guide plate facing the gap between the adjacent LED boards and therearound in the third embodiment.

FIG. 14 is a magnified cross-sectional view on an LED board side in a first modification of the third embodiment.

FIG. 15 is a magnified cross-sectional view on an LED board side in a second modification of the third embodiment.

### MODE FOR CARRYING OUT THE INVENTION

### First Embodiment

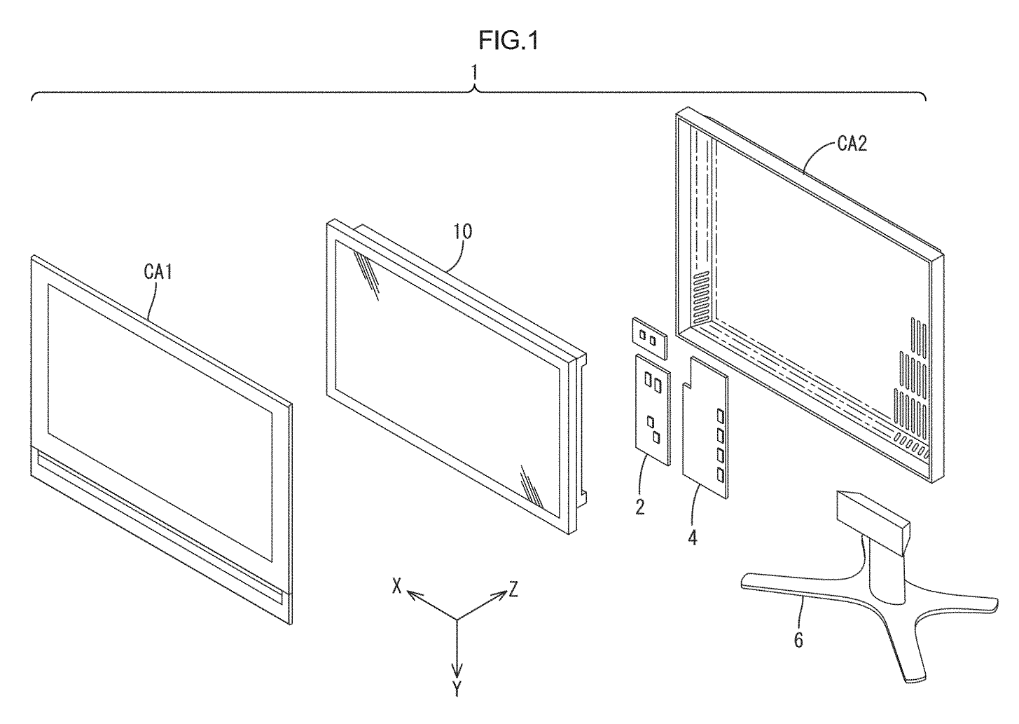

The first embodiment of the present invention will be described with reference to the drawings. In this section, a television device 1 will be described. As illustrated in FIG. 1, the television device 1 includes a liquid crystal display device 10 (an example of a display device), a front cabinet CA1, a rear cabinet CA2, a power supply 2, a tuner 4, and a stand 6. The front cabinet CA1 and the rear cabinet CA2 sandwich and hold the liquid crystal display device 10. An X-axis, a Y-axis, and a Z-axis may be present in the drawings. The axes in each drawing correspond to the respective axes in other drawings to indicate the respective directions. The X-axis direction, the Y=axis direction, and the Z-axis direction correspond to the horizontal direction, the vertical direction, and the thickness direction (the front-rear direction), respectively. In each of the drawings including perspective views and cross-sectional views the upper side corresponds to a front side of the liquid crystal display device 10.

The liquid crystal display device 10 has a horizontally-long rectangular overall shape. The liquid crystal display device 10 includes a liquid crystal panel 11 (an example of a display panel) and a backlight unit 12 (an example of a lighting device). The backlight unit 12 is an external light source. The liquid crystal panel 11 and the backlight unit 12 are collectively held by a bezel 13 that has a frame shape. In the liquid crystal display device 10, the liquid crystal panel 11 is held in a position such that a display surface 11C faces the front side and fixed. The display surface 11C is configured to display images. The liquid crystal panel 11 in this embodiment is a high definition panel that includes a larger number of pixels, that is, a so-called 4K2K panel. Namely, the liquid crystal panel 11 is a large-sized panel, for instance, a 32-inch panel.

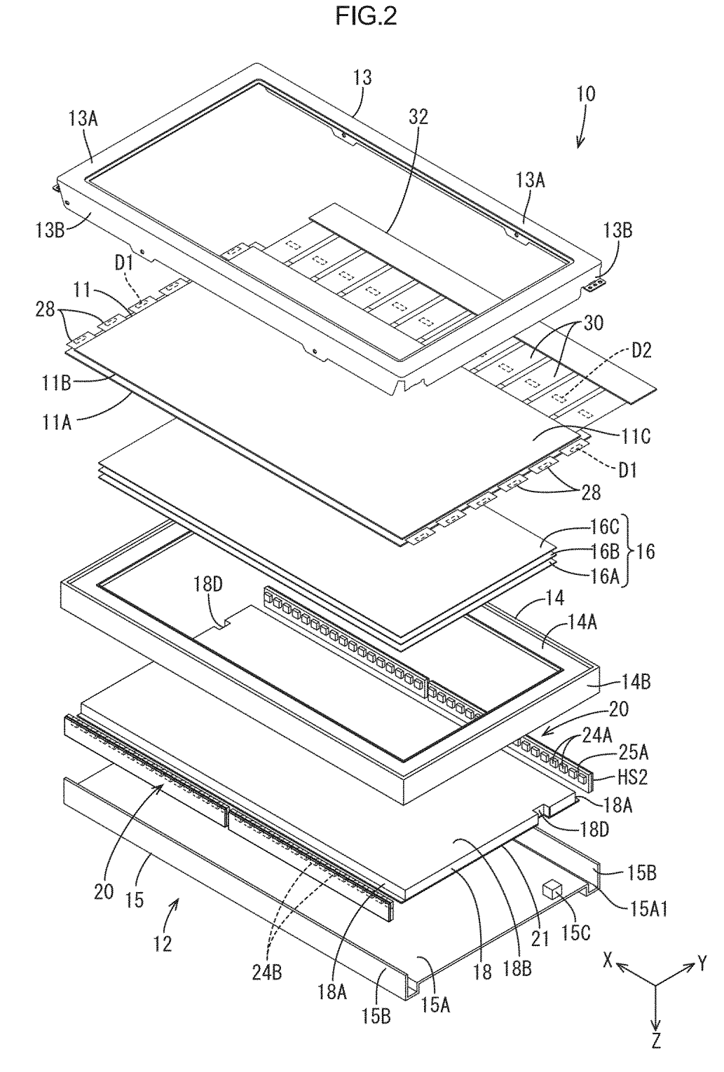

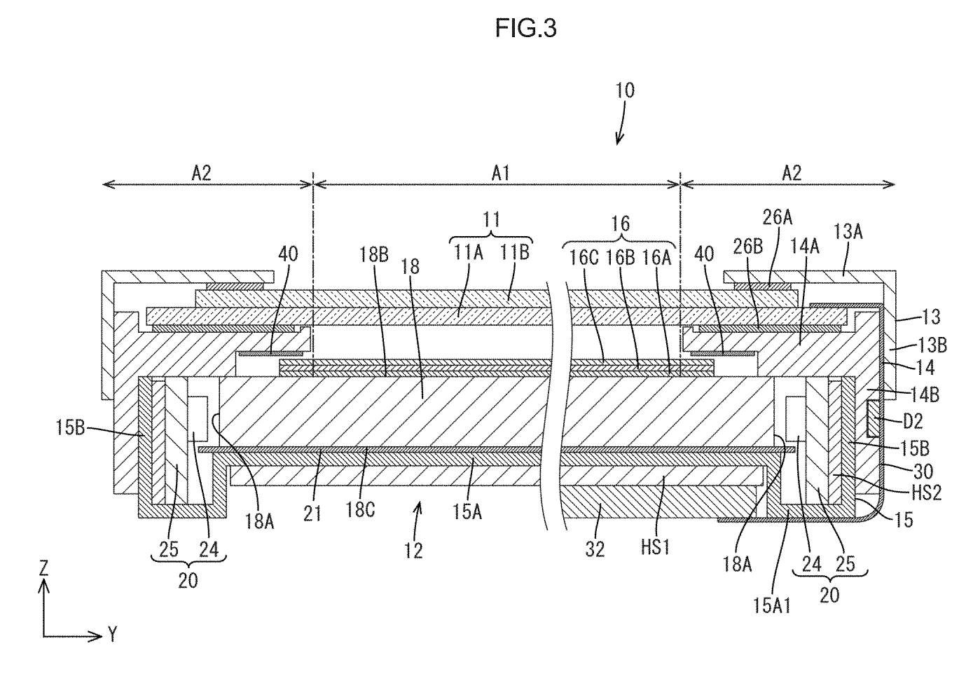

The bezel 13 is made of metal having high rigidity such as stainless steel. As illustrated in FIGS. 2 and 3, the bezel 13 includes a bezel frame portion 13A and a bezel peripheral portion 13B. The bezel frame portion 13A is parallel to the liquid crystal panel 11 and has a substantially frame shape in a plan view. The bezel peripheral portion 13B extends from an outer peripheral edge of the bezel frame portion 13A to the rear side. The bezel peripheral portion 13B has a short tubular shape. The bezel frame portion 13A extends along edges of the display surface 11C of the liquid crystal panel 11. A cushion 26A is disposed between the bezel frame portion 13A and the liquid crystal panel 11 (see FIG. 3). The bezel frame portion 13A presses the edges of the display surface 11C from the front side via the cushion 26A and holds the liquid crystal panel 11. The bezel peripheral portion 13B covers a portion of a frame 14, which will be described later, and forms outer surfaces of sidewalls of the liquid crystal display device 10.

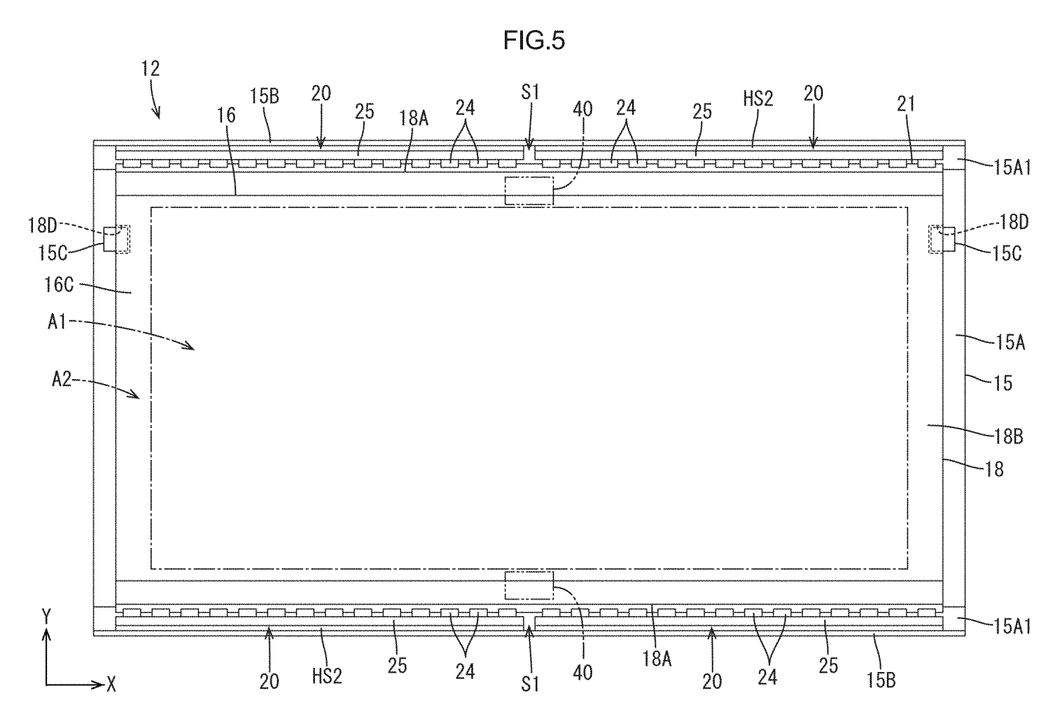

As illustrated in FIGS. 2 and 3, the liquid crystal panel 11 has a horizontally-long rectangular shape in a plan view. The liquid crystal panel 11 is disposed on the front side of the optical sheet bundle 16, which will be described later, with a predefined gap between the optical sheet bundle 16 and the liquid crystal panel 11. The liquid crystal panel 11 includes glass substrates 11A and 11B having high light transmissivity. The glass substrates 11A and 11B are bonded together with a predefined gap therebetween. Liquid crystals are enclosed between the substrates 11A and 11B. One of the substrates 11A and 11B on the rear side is an array substrate 11A. The other one on the front side is a color filter substrate 11B. As illustrated in FIG. 3, a large area of the liquid crystal panel 11 is a display area A1 that is configured to display images. An area outside the display area is a non-display area A2 in which the images are not displayed. In the liquid crystal panel 11, the display area A1 that is configured to display the images is in a large area of the display surface 11C. The area outside the display area A1 is the non-display area A2 having a frame shape to surround the display area A1 and covered with the bezel frame portion 13A of the bezel 13 and thus in which the images are not displayed (see FIGS. 3 and 5). Polarizing plates, which are not illustrated, are disposed on the outer sides of the substrates 11A and 11B.

On the array substrate 11A, switching components (e.g., TFTs) which are connected to source lines and gate lines that are perpendicular to each other, pixel electrodes connected to the switching components, and an alignment film are disposed. Specifically, on the array substrate 11A, the TFTs and the pixel electrodes are disposed and the gate lines and the source lines are routed in a grid to surround the TFTs and the pixel electrodes. The gate lines and the source lines are connected to gate electrodes and source electrodes, respectively. The pixel electrodes are connected to drain electrodes of the TFTs. On the color filter substrate 11B, color filters, counter electrodes, and an alignment film are disposed. The color filters include red (R), green (G), and blue (B) color portions in predefined arrangement.

As illustrated in FIGS. 2 and 3, the array substrate 11A is slightly larger than the color filter substrate 11B such that outer edges thereof project outward from the outer edges of the color filter substrate 11B for the entire periphery. Gate-side terminals (not illustrated) are disposed on short edge sections of the outer edge of the array substrate 11A. The gate-side terminals extend from the gate lines. A gate-side flexible circuit board 28 having flexibility is connected to the gate-side terminals. Source-side terminals (not illustrated) are disposed on one of long edge sections of the outer edge of the array substrate 11A (on the upper right side in FIG. 2). The source-side terminals extend from the source lines. A source-side flexible circuit board 30 having flexibility is connected to the source-side terminals.

As illustrated in FIG. 2, the gate-side flexible circuit board 28 and the source-side flexible circuit board 30 are made of synthetic resin having insulating properties and flexibility. A gate driver D1 for driving the liquid crystals is mounted on the back surface of the gate-side flexible circuit board 28. A source driver D2 is mounted on the back surface of the source-side flexible circuit board 30. The drivers D1 and D2 are protrusions that protrude inward from the mounting surfaces and have horizontally-long shapes. The drivers D1 and D2 include LSI chips inside. The LSI chips include drive circuit configured to process input signals related to the images supplied by a control circuit board (not illustrated), which is a signal source and to output signals to the liquid crystal panel 11. One of ends of the source-side flexible circuit board 30 is connected to the array substrate 11A and the other end is bent to a bottom plate 15A of a chassis 15 and connected to a source substrate 32 disposed on the back surface of the bottom plate 15A.

Next, a configuration of the backlight unit 12 will be described. As illustrated in FIG. 2, main components of the backlight unit 12 are held in a space between the frame 14 (an example of a frame member) and the chassis 15. The frame 14 forms a front exterior of the backlight unit 12. The chassis 15 forms a rear exterior of the backlight unit 12. The main components between the frame 14 and the chassis 15 include at least a light guide plate 18, a reflection sheet 21, and LED units 20. The light guide plate 18 is sandwiched between the frame 14 and the chassis 15 and held. The optical sheet bundle 16 is placed in layers on the front surface of the light guide plate 18. The LED units 20 are disposed in spaces between the frame 14 and the chassis 15 to sandwich the light guide plate 18 in the short direction of the light guide plate 18. Namely, the backlight unit 12 in this embodiment is a so-called edge light type.

The light guide plate 18 is made of substantially transparent synthetic resin (having high light transmissivity) having a refractive index sufficiently higher than that of the air (e.g., acrylic resin such as PMMA or polycarbonate). As illustrated in FIG. 2, the light guide plate 18 has a horizontally-long rectangular shape in a plan view similar to the liquid crystal panel 11 and the optical sheet bundle 16, which will be described later. The long direction and the short direction of the plate surface of the light guide plate 18 correspond with the X-axis direction and the Y-axis direction. Furthermore, the thickness direction of the light guide plate 18 perpendicular to the plate surface corresponds with the Z-axis direction. The light guide plate 18 is supported by the chassis 15, which will be described later. The long end surfaces of the light guide plate 18 on the long sides are the light entering surfaces 18A through which light rays emitted by the LED units 20 enter.

The light guide plate 18 is held in a position such that the light entering surfaces 18A are opposed to the LED units 20, the light exiting surface 18B that is a main plate surface (the front plate surface) facing the optical sheet bundle 16, and an opposite surface 18C that is an opposite plate surface from a light exiting surface 18B (the back plate surface) facing the reflection sheet 21, which will be described later. The light guide plate 18 is configured such that the light rays emitted by the LED units 20 enter through the light entering surfaces 18A, travel inside the light guide plate 18, and exit through the light exiting surface 18B. The light guide plate 18 directs the light rays inside the light guide plate 18 toward the optical sheet bundle 16. Although not illustrated, dot patterns are formed on the opposite surface 18C of the light guide plate 18 for reflecting the light rays. The short end surfaces of the light guide plate 18 on the short sides includes recesses 18D in edge positions closer to one of the light entering surfaces 18A. The recesses 18D are recessed inward (toward the middle of the light guide plate 18). Each recess 18D has a rectangular shape in a plan view and extends all the way through the light guide plate 18 in the thickness direction (the Z-axis direction).

The reflection sheet 21 has a rectangular sheet made of synthetic resin and a white surface having high light reflectivity. The reflection sheet 21 is sandwiched between the light guide plate 18 and the chassis 15 with the long direction and the short direction corresponding with the X-axis direction and the Y-axis direction, respectively. The reflection sheet 21 contacts the light guide plate 18 and the chassis 15. The reflection sheet 21 reflects light rays leaking from the LED units 20 or the light guide plate 18 to the surface of the reflection sheet 21.

As illustrated in FIG. 2, the optical sheet bundle 16 has a horizontally-long rectangular shape in a plan view similar to the light guide plate 18 and the liquid crystal panel 11. The optical sheet bundle 16 is lightly smaller than the light exiting surface 18B of the light guide plate 18 in the plan view. As illustrated in FIG. 3, the optical sheets cover the entire display area A1 of the liquid crystal panel 11 and edge portions of the optical sheets overlap the non-display area A2 of the liquid crystal panel 11. The optical sheet bundle 16 is disposed on the light exiting surface 18B of the light guide plate 18 with a predefined gap between the liquid crystal panel 11 and the optical sheet bundle 16. The optical sheet bundle 16 includes three optical sheets that are a diffuser sheet 16A, a prism sheet 16B, and a reflection type polarizing sheet 16C layered in this sequence from the light guide plate 18 side. The optical sheet bundle 16 is disposed between the light guide plate 18 and the liquid crystal panel 11 to pass the light rays from the light guide plate 18, add predefined optical effects to the passing light rays, and direct to the lighted crystal panel 11.

The chassis 15 forms the rear exterior of the liquid crystal display device 10. The chassis 15 is made of metal such as aluminum. As illustrated in FIG. 2, the chassis 15 has a horizontally-long shallow tray-like overall shape to cover a substantially entire back surface of the liquid crystal display device 10. The chassis 15 includes the bottom plate 15A and side plates 15B. The bottom plate 15A covers the back surface of the liquid crystal panel 11. The side plates 15B project from long edges of the bottom plate 15A toward the front side. The bottom plate 15A includes steps 15A1 at ends of the long edges. The steps 15A1 step down from the bottom plate 15A toward the rear side of the liquid crystal display device 10 (see FIG. 3). As illustrated in FIG. 3, a height (a dimension in the Z-axis direction) of each side plate 15B is about equal to a sum of the thickness of the light guide plate 18 and a height of the step 15A1. The side plates 15B cover entire back areas of the LED units 20 (opposite sides from light exiting sides of the LEDs 24).

As illustrated in FIGS. 2 and 5, the bottom plate 15A includes positioning protrusions 15C that protrude toward the front side (the liquid crystal panel 11 side) at ends of the long dimension of the bottom plate 15A. The positioning protrusions 15C are aligned with each other in the short direction of the bottom plate 15A (the Y-axis direction). The positioning protrusions 15C have block shapes and protrude in a direction perpendicular to the bottom plate 15A (the Z-axis direction) such that the positioning protrusions 15C are symmetric and sandwich the light guide plate 18. In a plan view in FIG. 5, about halves of the positioning protrusions 15C are fitted in the recesses 18D of the light guide plate 18 with substantially no gaps. With the positioning protrusions 15C, the light guide plate 18 is positioned relative to the bottom plate 15A.

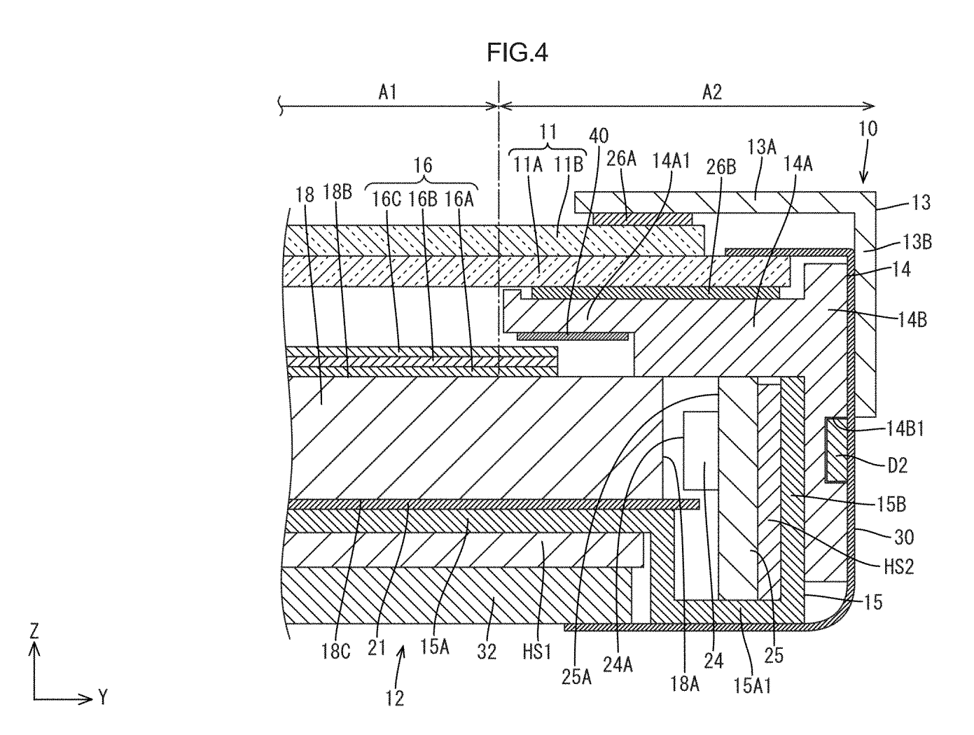

As illustrated in FIG. 4, a first heat dissipation sheet HS1 that is a sheet having heat dissipation properties is disposed between the bottom plate 15A of the chassis 15 and the source substrate 32. The first heat dissipation sheet HS1 are sandwiched between the bottom plate 15A of the chassis 15 and the source substrate 32 to contact the bottom plate 15A and the source substrate 32. According to the configuration, a space between the source substrate 32 and the bottom plate 15A of the chassis 15 is entirely occupied by the first heat dissipation sheet HS1. Heat transmitted from the LED units 20 to the bottom plate 15A of the chassis 15 is effectively transmitted from the bottom plate 15A to the source substrate 32 via the first heat dissipation sheet HS1.

The frame 14 is formed in a horizontally-long frame shape similar to the bezel 13 and made of synthetic resin. The frame 14 includes a frame portion 14A and a frame peripheral portion 14B. The frame portion 14A is formed in a substantially frame shape in a plan view and parallel to the liquid crystal panel 11. The frame peripheral portion 14B extends from outer peripheral edge of the frame portion 14A toward the front and the rear sides. The frame peripheral portion 14B has a short tubular shape. The frame portion 14A extends along the edges of the light exiting surface 18B of the light guide plate 18. A section of the frame portion 14A press the farthest section of the edge of the light exiting surface from the front side to hold the light guide plate 18 between the bottom plate 15A of the chassis 15 and the frame portion 14A. The frame portion 14A includes a covering section 14A1 that covers the edges of the light exiting surface 18B and the optical member bundle 16 from the front side (see FIG. 4). A cushion 26B is disposed between the frame portion 14A and the liquid crystal panel 11. The frame portion 14A supports the edges of the liquid crystal panel 11 from the rear side via the cushion 26B.

The frame peripheral portion 14B includes sections that extend from the outer peripheral edges of the frame portion 14A toward the rear side longer than sections of the frame peripheral portion 14B that extend from the outer peripheral edges toward the front side. The sections that extend toward the rear side are against large areas of the side plates 15B of the chassis 15 and form portions of side exterior of the liquid crystal display device 10. The section of the frame peripheral portion against one of the side plates 15B includes a driver holding recess 14B1 that opens outward and holds the source driver D1 therein (see FIG. 4). The source driver D2 is held in the driver holding recess 14B1 without contact. If heat is produced by the source driver D2 while the source driver D2 is turned on, a large amount of the heat is transmitted to the mounting portion of the source-side flexible circuit board 30 on which the source driver D2 is mounted.

As illustrated in FIGS. 2 and 5, the LED units 20 are disposed along the long edges of the light guide plate 18 such that two LED units 20 are disposed along each long edge of the light guide plate 18, that is, each light entering surface 18A of the light guide plate 18. Namely, four LED units 20 are held inside the chassis 15. Each LED unit 20 includes an LED board 25 and LEDs 24 that are mounted on the LED board 25.

Each LED 24 in each LED unit 20 includes a substrate that is fixed to the LED board 25 and an LED chip (not illustrated) which is enclosed with a resin. The LED chip that is mounted on the substrate is configured to emit light with one kind of main emitting wavelength, specifically, light in a single color of blue. In the resin that encloses the LED chip, phosphors are dispersed. The phosphors emit light in predefined colors when excited by the blue light emitted by the LED chip. According to the configuration, the LED 24 emits white light. Different kinds of phosphors such as yellow phosphors that emit yellow light, green phosphors that emit green light, and red phosphors that emit red light may be used for the phosphors. An appropriate combination of the kinds of the phosphors or a single kind of the phosphors may be used. The LED 24 includes an opposite surface from the surface that is fixed to the LED board 25. The opposite surface is a main light exiting surface and thus the LED 24 is referred to as a top surface light emitting type LED.

The LED boards 25 in the LED units 20 are made of aluminum that has high heat dissipation properties. As illustrated in FIGS. 2 and 5, each LED board 25 has an elongated plate shape that extends in the long direction of the light guide plate 18 (the X-axis direction). The LED units 20 are held in the vertical position and supported by the steps 15A of the bottom plate 15A of the chassis 15. Specifically, the LED boards 25 are disposed with the plate surfaces parallel to the X-axis direction and the Z-axis direction, that is, to the light entering surfaces 18A of the light guide plate 18. Each LED board 25 has a dimension in the long direction thereof (the X-axis direction) about a half of the dimension of the light guide plate 18 in the long direction thereof. Two LED boards 25 are disposed along the corresponding light entering surface 18A of the light guide plate 18 with a predefined gap therebetween. Each LED board 25 has a dimension in the short direction about equal to a sum of the thickness of the light guide plate 18 and a dimension of the step in the projecting direction (see FIG. 3).

The LEDs 24 are mounted on plate surfaces of the LED boards 25 on the inner sides, that is, the plate surfaces facing the light guide plate 18. The plate surfaces are referred to as the mounting surfaces 25A. The LEDs 24 are directly soldered to the mounting surfaces 25A of the LED boards 25 with a light emitting surfaces 24A opposed to the light entering surfaces 18A of the light guide plate 18. The LEDs 24 are arranged in line (linearly) at about equal intervals on the mounting surface 25A of each LED board 25 in the longitudinal direction of the LED board 25 (the X-axis direction). Wiring patterns, which are not illustrated, are formed on the mounting surfaces 25A of the LED boards 25 for supply driving power to the LEDs 24. The wiring patterns are formed from a metal film (a copper foil). As illustrated in FIG. 3, second heat dissipation sheets HS2 having heat dissipating properties are disposed between the LED boards 25 and the side plates 15B of the chassis 15. The second heat dissipation sheets HS2 are disposed between the LED boards 25 and the side plates 15B to contact the LED boards 25 and the side plates 15B. According to the configuration, some amount of the heat effectively transmitted to the side plates 15B via the second heat dissipation sheets HS2.

In the backlight unit 12 according to this embodiment, as illustrated in FIG. 3, light reflecting members 40 having the light reflectivity are disposed in areas of the covering section 14A1 of the frame portion 14A of the frame 14 on the rear side. Each light reflecting member 40 has a sheet shape with one of surfaces have adhesive properties and are bonded to the covering section 14A1. Specifically, as illustrated in FIGS. 3 and 5, the light reflecting members 40 are opposed to sections of the edges of the light exiting surface 18B of the light guide plate 18 on the respective light entering surface 18A sides facing spaces S1 between the adjacent LED boards 25, respectively. As illustrated in FIG. 5, larger sections of the light reflecting members 40 are opposed to the light exiting surface 18B of the light guide plate in a plan view of the backlight unit 12. Some areas of the sections overlap the optical sheet bundle 16. As illustrated in FIG. 5, the light reflecting members 40 are disposed in the non-display area A2 of the liquid crystal panel 11 at positions closer to the boundary between the non-display area A2 and the display area A1.

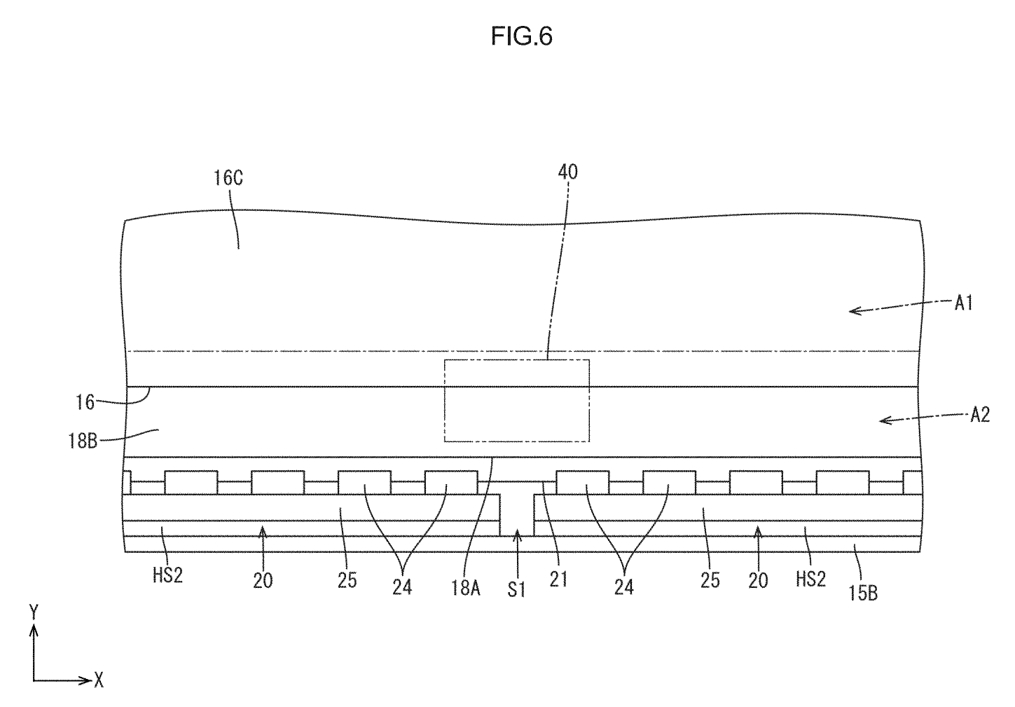

In the backlight unit 12 according to this embodiment, as illustrated in FIG. 6, a distance between the adjacent LEDs 24 in the space S1 between two LED boards 25 is larger than a distance between the adjacent LEDs 24 mounted on the mounting surface 25A of the LED board 25. If the light reflecting members 40 are not present, the sections of the edges of the light exiting surface 18B of the light guide plate 18 facing the spaces S1 between the adjacent LED boards 25 on the respective light entering surface 18A sides may be darker than other sections. Namely, the sections may be recognized as dark spots. If such dark spots extend to the display area A1 of the liquid crystal panel 11, uneven brightness resulting from the dark spots may occur in an image displayed on the display surface 11C.

In the backlight unit 12 according to this embodiment, the light reflecting members 40 having the light reflectivity are disposed as described earlier. Therefore, light rays that have exited the light guide plate 18 through the light exiting surface 18B and reached the light reflecting members 40 are reflected to the sections of the light exiting surface 18B of the light guide plate 18 on the lighter entering surface 18A sides facing the spaces S1 between the adjacent LED boards 25 by the light reflecting member 40. According to the configuration, the reflected light rays reach the dark sports in the sections facing the spaces S1 and therearound. Therefore, the dark spots in the non-display area and the dark spots in the display area A1 can be eliminated. The dark spots are less likely to be produced in the light exiting the light guide plate 18 through the light exiting surface 18B. Therefore, the uneven brightness resulting from the dark spots are less likely to occur in the image displayed on the display surface 11C of the liquid crystal display panel 11.

In a configuration in which a reflection member is disposed on a light exiting surface of a light guide plate, if optical sheets on the light exiting surface thermally is expanded, the optical members may contact the light reflection member. In this embodiment, as described earlier, the light reflecting members 40 are bonded to the section of the frame 14, that is, the covering section 14A1 of the frame 14. Therefore, the light reflecting members 40 are less likely to contact other components due to thermal expansion of the other components.

In general, a metal LED board delivers higher heat dissipation performance in comparison to a resin LED board. However, a length of the metal LED board in an extending direction is smaller than that of the resin LED board. Therefore, in a large-sized backlight unit, a large number of LED boards need to be arranged along a light entering surfaces of a light guide plate. In the backlight unit 12 according to this embodiment, the large number of the LED boards 25 made of aluminum are arranged, the uneven brightness resulting from the dark spots in the sections of the edges of the light guide plate 18 facing the spaces S1 between the adjacent LED boards 25 is less likely to occur. The backlight unit 12 can be increases in size and heat dissipation properties while occurrence of the uneven brightness is reduced.

<First Modification of First Embodiment>

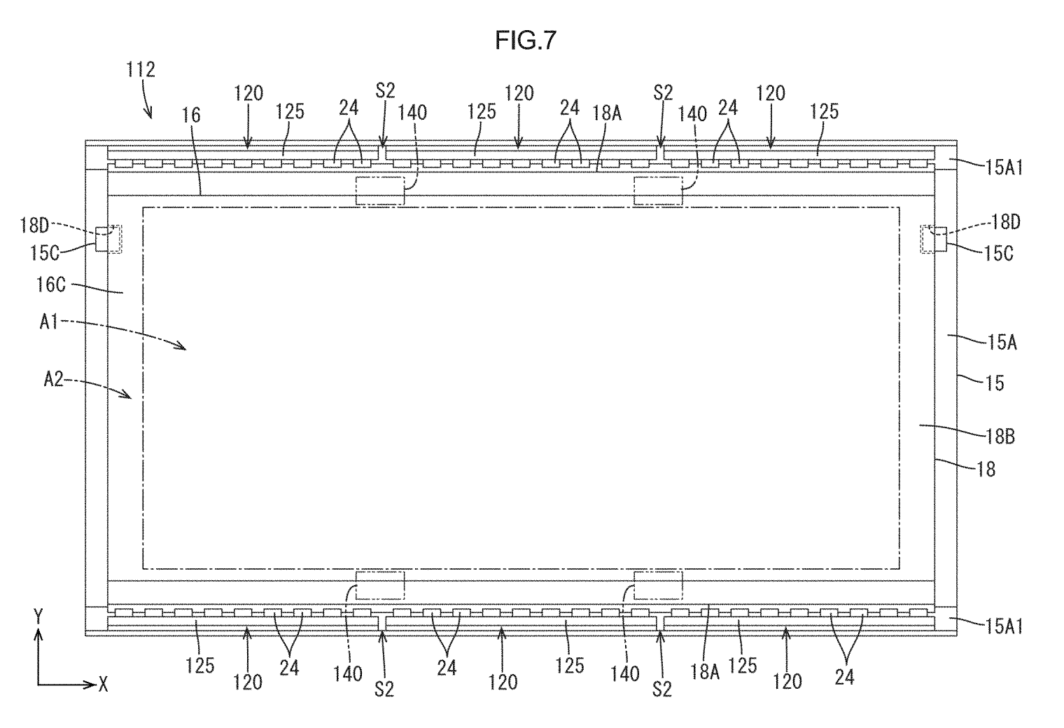

A first modification of the first embodiment will be described with reference to FIG. 7. This modification includes a backlight unit 112 that includes LED units 120 and light reflecting members 140, the numbers of which are different from those of the first embodiment. Other configurations are similar to those of the first embodiment. As illustrated in FIG. 7, the backlight unit 112 according to this modification includes six LED units 20 held in the chassis 15. Namely, LED boards 125 included in the LED units 120 have a length smaller than that of the first embodiment. Three LED boards 125 are arranged at predefined intervals along the corresponding light entering surface 18A of the light guide plate 18. Four light reflecting members 140 are held in the chassis 15. The light reflecting members 140 are opposed to sections of edges of the light exiting surface 18B of the light guide plate 18 facing spaces S2 between the adjacent LED boards 125 on the light entering surface 18A sides.

In this modification, the number of the LED units 120 and the number of the light reflecting members 140 are different from those of the first embodiment. However, the light rays that have exited the light guide plate 18 through the light exiting surface 18B and reached the light reflecting members 140 are reflected by the light reflecting members 140 toward the sections of the edges of the light exiting surface 18B of the light guide plate 18 facing the spaces S2 between the adjacent LED boards 125 on the light entering surface 18A sides. According to the configuration, the light rays reach the dark spots in the sections facing the spaces S2 and therearound and thus not only the dark spots in the non-display area A2 but also the dark spots in the display area A1 can be eliminated. Therefore, the uneven brightness resulting from the dark spots is less likely to occur in the image displayed on the display surface of the display device.

<Second Modification of First Embodiment>

A second modification of the first embodiment will be described. In a backlight unit according to this modification, a covering section of a frame in which the light reflecting members 40 in the first embodiment are disposed is painted in white to configure the entire covering section as a light reflecting member having light reflectivity. Therefore, light reflecting members having a sheet shape are not disposed in the covering section. In this modification, the covering section is painted in white and configured as the light reflecting member. Therefore, the thickness of the light reflecting member is equal to the thickness of the paint. In comparison to the configuration of the first embodiment in which the reflection members having the sheet shape are provided, the thickness of the light reflecting member can be reduced. Therefore, the thickness of the backlight unit can be reduced.

### Second Embodiment

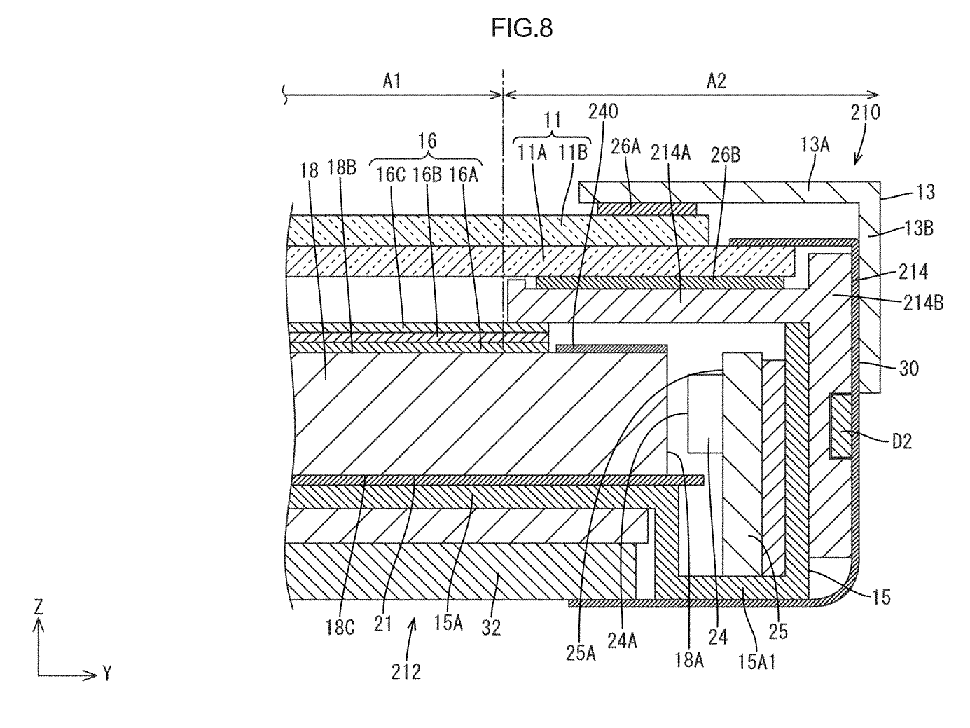

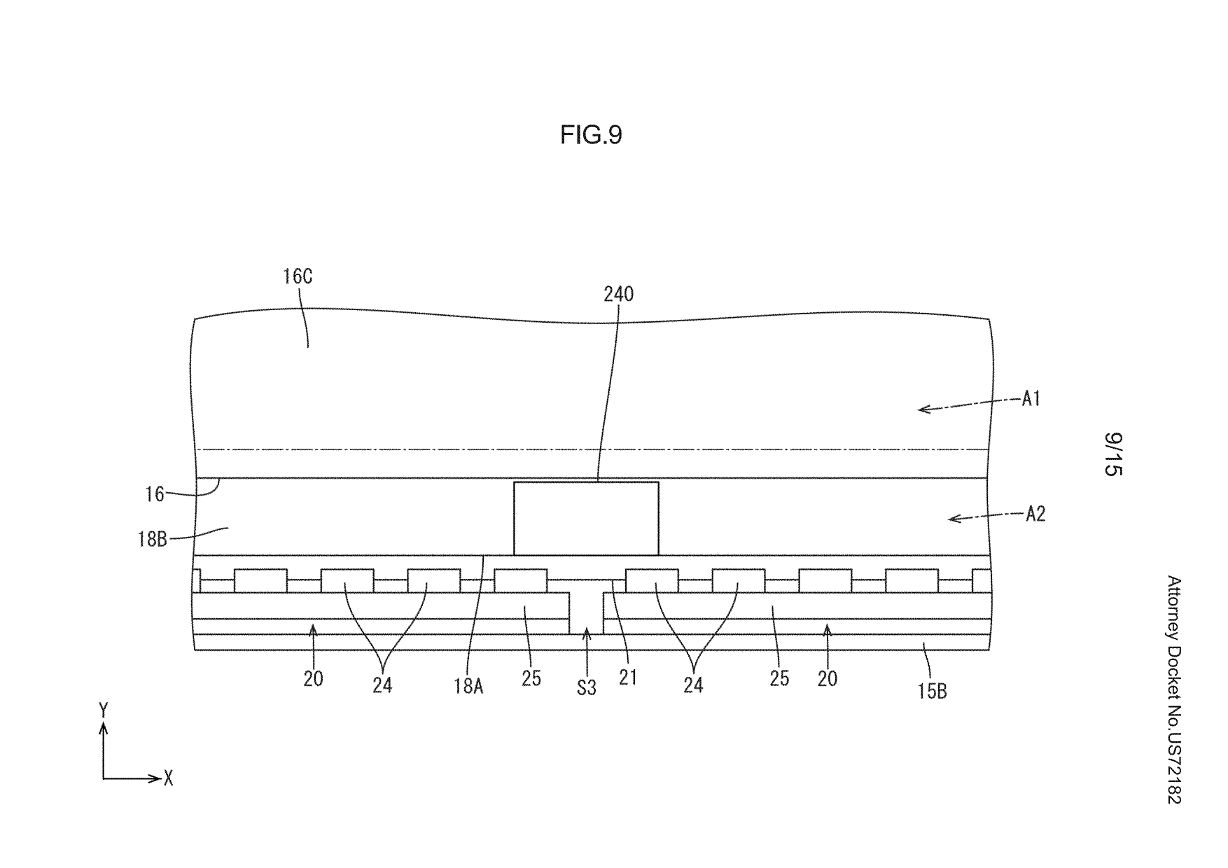

A second embodiment of the present invention will be described with reference to FIGS. 8 to 10. The second embodiment includes light reflecting members 240 having a configuration differently from that of the first embodiment. Other configurations are similar to those of the first embodiment and thus will not be described. As illustrated in FIG. 8, in a backlight unit 212 according to this embodiment, the light reflecting members 240 are bonded to the light exiting surface 18B of the light guide plate 18. Specifically, as illustrated in FIG. 9, the light reflecting members 240 are bonded to sections of the edges of the light exiting surface 18B of the light guide plate 18 facing spaces S3 between the adjacent LED boards 25 on the light entering surface 18A sides.

In this embodiment, the light reflecting members are arranged as described above. Therefore, light rays traveling toward the sections of the light exiting surface 18B of the light guide plate 18 to which the light reflecting members 240 are bonded are reflected by the light reflecting members 240 toward the sections of the light guide plate 18 facing the spaces S3 between the adjacent LED boards 125 and therearound. The reflected light rays reach dark spots in the sections of the edges of the light exiting surface 18 of the light guide plate 18 facing the spaces S3 between the LED boards 25 on the light entering surface 18A sides and therearound. As a result, not only the dark spots in the non-display area A2 of the liquid crystal panel but also the dark spots in the display area A1 can be eliminated. Therefore, the uneven brightness resulting from the dark spots in the image displayed on the display surface of the liquid crystal panel 11 is less likely to occur.

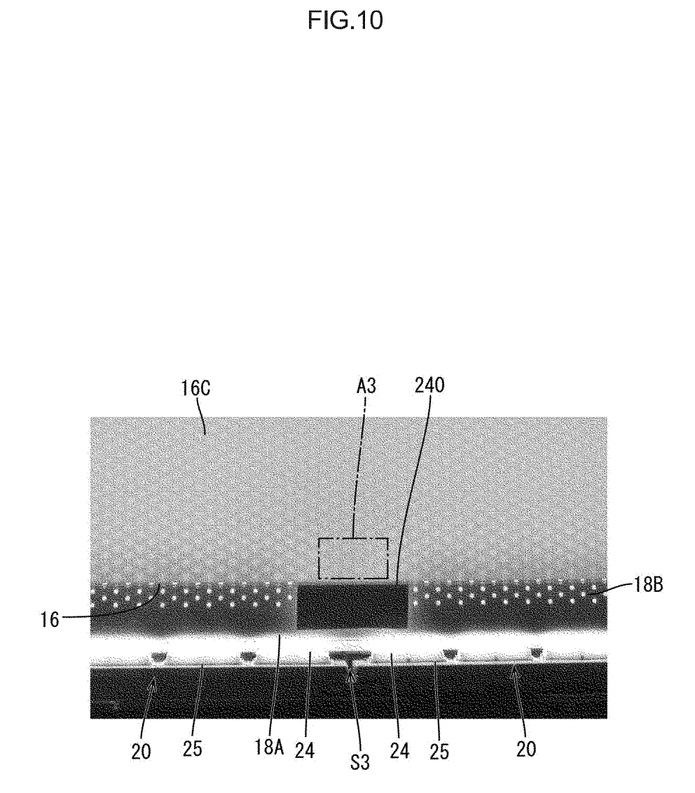

A picture in FIG. 10 illustrates brightness in the section of the edge of the light exiting surface 18B of the light guide plate 18 facing the space S3 between the adjacent LED boards 25 on the light entering surface 18A side and therearound. As illustrated in FIG. 10, in the section of the edge of the light exiting surface 18B of the light guide plate 18 facing the space S3 between the adjacent LED boards 25 on the light entering surface 18A side and therearound, a differences in brightness in comparison to other sections of the light exiting surface 18B of the light guide plate 18 is barely observed in a region A3 in the display area A1. With the light reflecting member 240, not only the dark spots in the non-display area A2 of the liquid crystal panel 11 but also the dark spots in the display area A1 are eliminated. In the picture in FIG. 10, round spots on the light guide plate 18 are the light reflecting dot pattern formed on the opposite surface 18C of the light guide plate 18.

### Third Embodiment

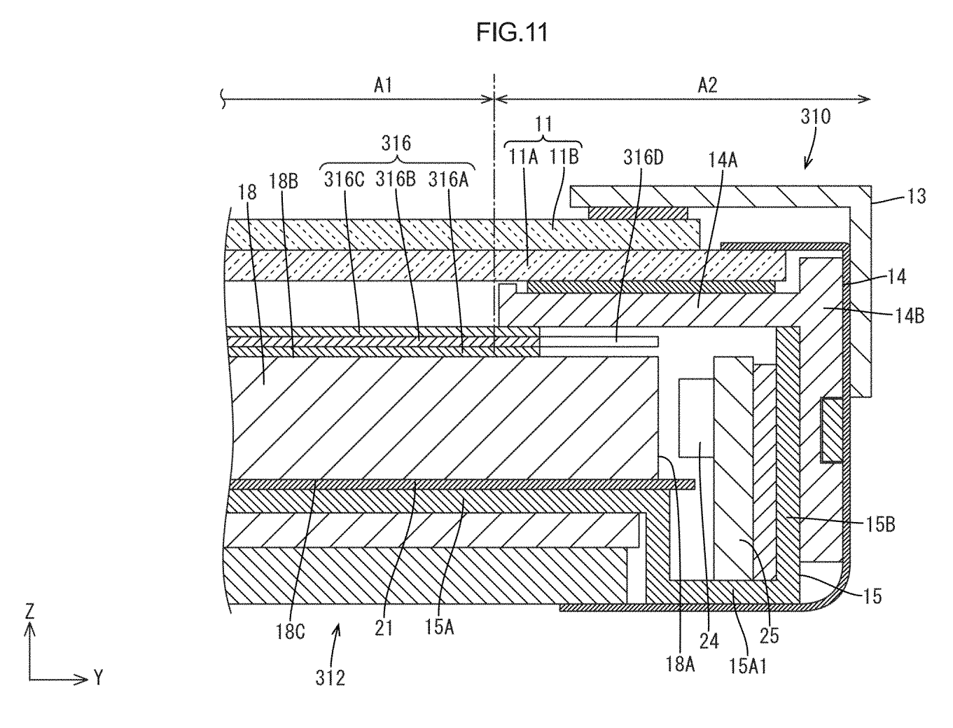

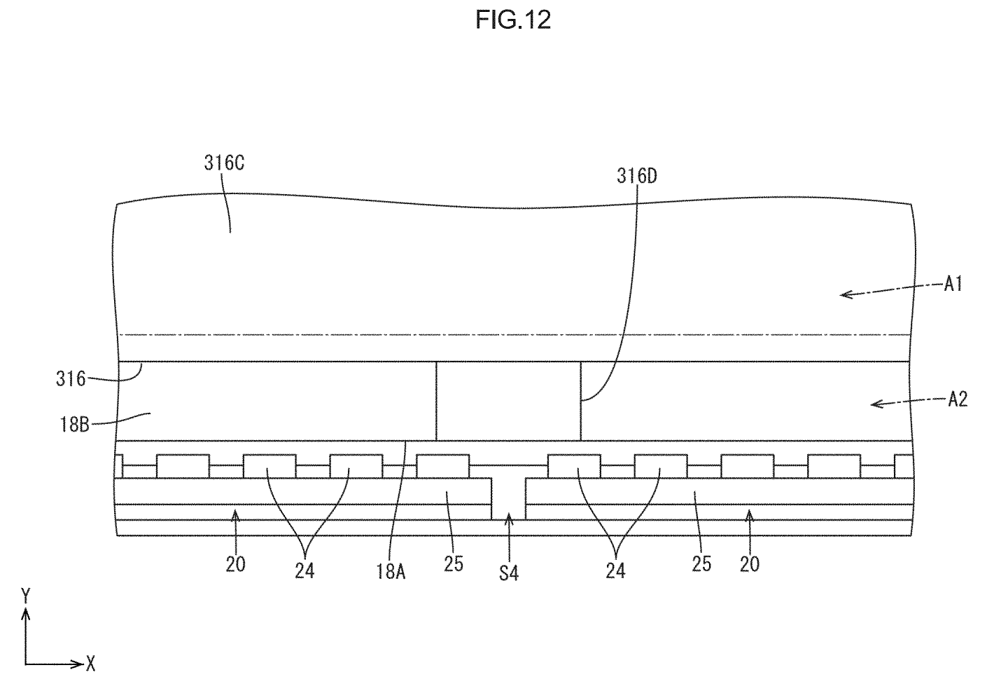

A third embodiment will be described with reference to FIGS. 11 to 13. As illustrated in FIGS. 11 and 12, a backlight unit 312 according to the third embodiment includes an optical sheet bundle 316 including optical sheets 316A, 316B, and 316C. The optical sheet 316B is a prism sheet 316B that includes a protrusion 316D (an example of a light diffusing member) which protrudes from a section of an edge of the prism sheet 316B closer to the light entering surface 18A of the light guide plate 18 toward the LED board 25. Specifically, the protrusion 316D is opposed to a section of the edge of the light exiting surface 18B of the light guide plate 18 on the light entering surface 18A side facing a space S4 between the adjacent LED boards 25. The protrusion 316D has light diffusing properties. As illustrated in FIG. 12, the protrusion 316D is located in the non-display area A2 of a liquid crystal panel 311 closer to a boundary between the display area A1 and the non-display area A2. Other configurations of the liquid crystal display device 310 according to this embodiment are similar to those of the first embodiment and thus will not be described.

In the backlight unit 312 according to this embodiment, the protrusion 316D having the light diffusing properties is arranged as described above. Light rays that have exited the light guide plate 18 through the light exiting surface 18B and reach the protrusion 316D are diffused by the protrusion 316D to the section of the light exiting surface 18B of the light guide plate 18 facing the space S4 between the adjacent LED boards 25 on the light entering surface 18A side. The light rays are diffused to the section facing the space S4 and therearound. The brightness in dark spots in the section facing the space S4 and therearound increases and thus the difference in brightness between the dark spots and other areas is reduced. Therefore, dark spots are less likely to be produced in light exiting the light guide plate 18 through the light exiting surface 18B. The uneven brightness resulting from the dark spots is less likely to occur in the image displayed on the display surface of the liquid crystal panel 11.

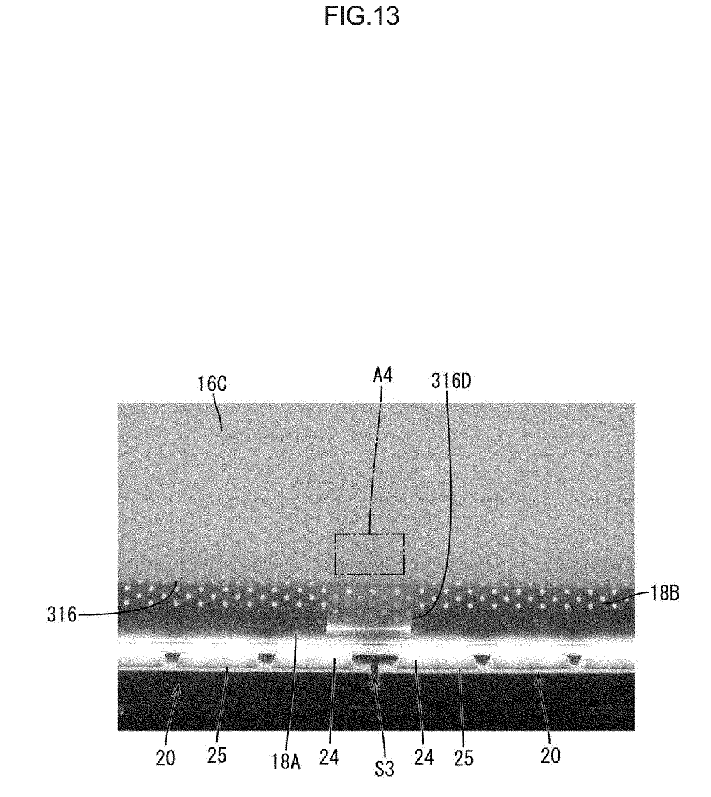

A picture in FIG. 13 illustrates brightness in the section of the edge of the light exiting surface 18B of the light guide plate 18 facing the space S4 between the adjacent LED boards 25 on the light entering surface 18A side and therearound. As illustrated in FIG. 13, in the section of the edge of the light exiting surface 18B of the light guide plate 18 facing the space S4 between the adjacent LED boards 25 on the light entering surface 18A side and therearound, a differences in brightness in comparison to other sections of the light exiting surface 18B of the light guide plate 18 is barely observed in a region A4 in the display area A1. With the protrusion 316D of the prism sheet 316B of the optical sheet bundle 316, not only the dark spots in the non-display area A2 of the liquid crystal panel 11 but also the dark spots in the display area A1 are eliminated.

<First Modification of Third Embodiment>

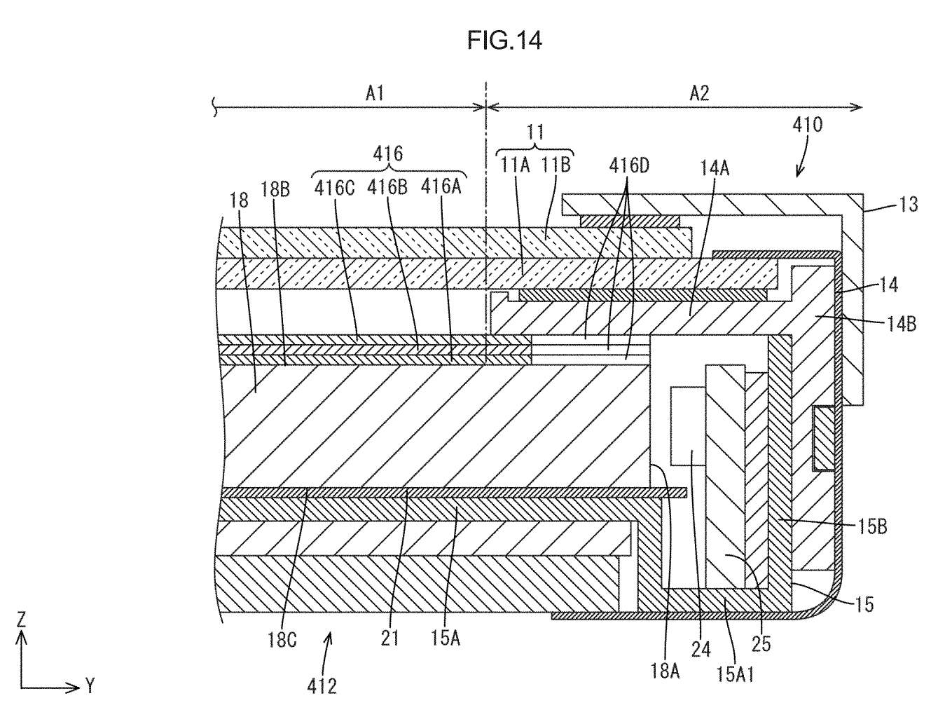

A first modification of the third embodiment will be described with reference to FIG. 14. In a backlight unit 412 according to this modification, as illustrated in FIG. 14, all optical sheets of an optical sheet bundle 416, that is, a diffuser sheet 416A, a prism sheet 416B, and a reflective polarizing sheet 416C include protrusion 416D having light diffusing properties described in the fourth embodiment section at sections of edges, respectively. The shape and the positions of the protrusions 416D are similar to those of the fourth embodiment. The protrusions 416D are on top of each other in the thickness direction of a light guide plate 418 (the Z-axis direction).

In the backlight unit 412 according to this modification, all optical sheets in the optical sheet bundle 416 include the protrusions that are on top of each other. In comparison to the fourth embodiment, effects for diffusing the light rays that have reached the protrusions 416D can be improved. The light rays are further diffused by the protrusions 416D to the sections of the edges of the light exiting surface of the light guide plate 18 facing the spaces between the adjacent LED boards 25 on the light entering surface 18A sides and therearound. The brightness in the dark spots in the sections facing the spaces and therearound is further increased. The uneven brightness resulting from the dark spots in the image displayed on the display surface of the liquid crystal panel 11 can be effectively suppressed.

<Second Modification of Third Embodiment>

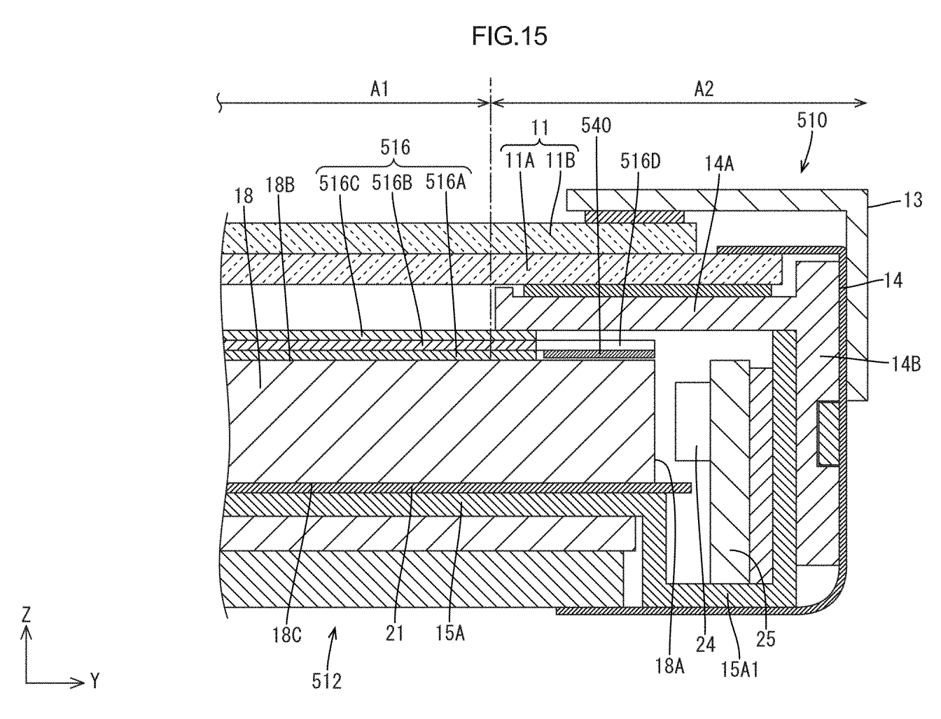

A first modification of the third embodiment will be described with reference to FIG. 15. As illustrated in FIG. 15, a backlight unit 512 according to this modification includes the optical sheet bundle 416 that includes a prism sheet 426 with the protrusion 416D similar to the fourth embodiment. However, other optical sheets do not include the protrusions 416D. The backlight unit 512 further includes a light reflecting member 540 having a configuration similar to that of the light reflecting members 40 described in the first embodiment section. The light reflecting member 540 is bonded to the back surface of the protrusion 416D (on a side opposed to the light exiting surface 18B of the light guide plate 18).

According to the configuration, the backlight unit 512 according to this modification can achieve the same effects that are achieved by the backlight unit 12 according to the first embodiment. Light rays that have exited the light guide plate 18 through the light exiting surface 18B and reached the light reflecting member 540 are reflected by the light reflecting member 540 toward the section of the edge of the light exiting surface 18B of the light guide plate 18 facing the space between the adjacent LED boards 25 on the light entering surface 18A side. Dark spots are less likely to be produced in light exiting the light guide plate 18 through the light exiting surface 18B. Therefore, the uneven brightness resulting from the dark spots is less likely to occur in the image displayed on the display surface 11C of the liquid crystal panel 11.

Modifications of the above embodiments will be listed below.

(1) In each of the first embodiment, the modification of the first embodiment, and the second embodiment, the light reflecting member having the sheet shape or the section of the frame configured as the light reflecting member by paining the section in white is provided. However, the configuration is not limited to those in the above embodiments or the modification as long as the light reflecting member has the light reflectivity.

(2) In each of the third embodiment and the modifications of the third embodiment, the optical sheet bundle includes protrusions at the sections of the optical sheet bundle. However, the shapes of the protrusions are not limited to those of the embodiment and the modifications. For instance, protrusions may be formed in a hemisphere shape or a pyramid shape.

(3) In the third embodiment and the first modification of the third embodiment, the protrusions formed at the sections of the optical sheet bundle are configured as the light diffusing members. However, the configuration of the light diffusing members is not limited. For instance, the backlight unit may include a light diffusing member having a sheet shape.

(4) In each of the above embodiments, the long edge surfaces among the end surfaces of the light guide plate are configured as the light entering surfaces and the LED boards are opposed to the light entering surfaces. However, all end surfaces of the light guide plate may be configured as light entering surfaces and LED boards may be disposed to be opposed to the light entering surfaces. In such a configuration, the light reflecting members or light diffusing members may be disposed to be opposed to sections of the edges of the light exiting surface of the light guide plate facing spaces between the adjacent LED boards on the light entering surface sides. According to the configuration, the uneven brightness resulting from the dark spots is less likely to occur in the image displayed on the display surface of the liquid crystal panel.

(5) In each of the above embodiments, the high definition liquid crystal panel is provided. However, the present invention can be applied to display panels that are not high definition display panels. For instance, by applying the present invention to a liquid crystal panel with high color reproducibility, uneven brightness resulting from the dark spots is less likely to occur in an image displayed on the display surface of the liquid crystal panel.

(6) In each of the above embodiment sections, the television device including the cabinets is described. However, the present invention can be applied to television devices without cabinets.

(7) In each of the above embodiment sections, the television device including the high definition liquid crystal panel is described. However, the present invention can be applied to display devices other than the television device.

Embodiments of the present inventions have been described in detail above. However, the embodiments are only examples and not limit claims. Technologies described in the claims include various modification and alteration of the embodiments.

### EXPLANATION OF SYMBOLS

1: Television device
CA1, CA2: Cabinet
10, 210, 310: Liquid crystal display device
11: Liquid crystal panel
12, 112, 212, 312: Backlight unit
13: Bezel
14, 214: Frame
14A: Frame portion
14A1: Covering section
14B: Frame peripheral portion
15: Chassis
15A: Bottom plate
15A1: Step
16, 316, 416, 516: Optical sheet
316D, 416D, 516D: Protrusion
18: Light guide plate
20: LED unit
21: Reflection sheet
24: LED
25, 125: LED board
25B, 125B, 225B: Second LED board
40, 140, 240, 540: Light reflecting member
A1: Display area
A2: Non-display area
S1, S2, S3, S4: Space between adjacent LED boards

1. A lighting device comprising:
light sources;
a light guide plate comprising:
at least an end surface configured as a light entering surface through which light rays from the light sources enter; and
one of plate surfaces configured as a light exiting surface through which the light rays entering through the light entering surface exit;
light source boards including plate surfaces configured as mounting surfaces on which the light sources are mounted and being disposed along the light entering surface with the mounting surfaces opposed to the light entering surface, each mounting surface being one of plate surfaces of each light source board; and
a light reflecting member having light reflectivity and being opposed to a section of an edge of the light exiting surface facing a space between the adjacent light source boards on a light entering surface side.

2. The lighting device according to claim 1, further comprising a frame member including a covering section covering an edge of the light exiting surface, wherein
the light reflecting member is bonded to an area of the covering section.

3. The lighting device according to claim 1, further comprising a frame member including a covering section covering an edge of the light exiting surface, wherein
the light reflecting member is an area of the covering section painted in white.

4. The lighting device according to claim 1, wherein
the light reflecting member is bonded to an area of a section of an edge of the light exiting surface on a light entering surface side.

5. The lighting device according to claim 1, further comprising an optical sheet bundle including optical sheets disposed in layers on the light exiting surface, wherein
the optical sheet located at an upper side among the optical sheets includes a protrusion protruding toward the light source board at an edge of the optical sheet on a light entering surface side, and
the light reflecting member is bonded to the protrusion.

6. A lighting device comprising:
light sources;
a light guide plate comprising:
at least an end surface configured as a light entering surface through which light rays from the light sources enter; and
one of plate surfaces configured as a light exiting surface through which the light rays entering through the light entering surface exit;
light source boards including plate surfaces configured as mounting surfaces on which the light sources are mounted and being disposed along the light entering surface with the mounting surface opposed to the light entering surface, each mounting surface being one of plate surfaces of each light source board; and
a light diffusing member having a light diffusing property and being opposed to a section of an edge of the light exiting surface of the light guide plate facing a space between the adjacent light source boards on a light entering surface side.

7. The lighting device according to claim 6, further comprising an optical member including optical sheets disposed in layers on the light exiting surface and configured to exert optical effects on light rays exiting from the light exiting surface, wherein
at least one of the optical sheets includes a protrusion protruding toward the light source board at an edge of the optical sheet on a light entering surface side, and
the protrusion is the light diffusing member.

8. The lighting device according to claim 1 the light source boards are made of metal.

9. A display device comprising:
the lighting device according to claim 1; and
a display panel configured to display an image using light from the lighting device.

10. A television device comprising the display device according to claim 9.
